(19) United States
(12) Patent Application Publication
(10) Pub. No.: US 2016/0281956 A1
(43) Pub. Date: Sep. 29, 2016

(54) SPREAD LIGHT LENS AND LED STRIP LIGHTS HAVING SAME

(71) Applicant: Self Electronics Co., Ltd., Ningbo (CN)

(72) Inventors: Feng Ji, NINGBO (CN); Zuping He, NINGBO (CN)

(73) Assignees: Wanjiong Lin, NINGBO (CN); Self electronics USA Corporation, Norcross (CN); Self Electronics Co., Ltd.

(21) Appl. No.: 15/068,308

(22) Filed: Mar. 11, 2016

(30) Foreign Application Priority Data
Mar. 27, 2015 (CN) CN201510138587.7

(51) Int. Cl. F21V 5/04; F21S 4/20

(52) U.S. Cl. CPC F21V 5/04; F21V 5/048; F21S 4/20; F21Y 2101/02

(57) ABSTRACT

An LED strip light includes a printed circuit board, a plurality of LED chip, and a lens group. The lens group includes at least two spread light lenses. The spread light lenses include an optical axis, a light emitting surface, a central point of the light emitting surface, and a light incidence surface arranged at interval with the light emitting surface. A ligature between the central point of the light emitting surface and the central point of the light incidence surface is perpendicular to the light incidence surface and an angle between the ligature and the optical axis is equal to an angle between the light emitting surface and the light incidence surface to deflect the light emitted from the light emitting surface. The LED strip lights can avoid forming bad lighting regions which have dramatic light and shade contrast, and contribute to improve luminous efficacy of light source.

### RELATED APPLICATION

This present application claims benefit of the Chinese Application, CN201510138587.7, filed on Mar. 27, 2015.

### BACKGROUND

1. Technical Field

The present application relates to lighting devices, and more particularly to a spread light lens and LED strip lights having same to form uniform illumination in the illumination area.

2. Description of the Related Art

Light emitting diode (LED) is growing in popularity due to decreasing costs and long life compared to incandescent lighting and fluorescent lighting. LED lighting can also be dimmed without impairing the useful life of the LED light source.

Recently, a number of LED lighting apparatuses have been designed to replace the halogen apparatus, as well as other traditional incandescent or fluorescence lighting apparatuses. But, due to mediocre light output, LED used in the past was primarily limited to applications where only small surface areas were illuminated. Usually, the LED light apparatuses includes at least one lens having unified specification in order to be convenient to centralized purchase and assembly and be ensure uniform illumination along length direction of the LED light apparatuses. Otherwise, illumination region of the LED light apparatuses is larger than the illuminated area so as that light can fully cover the illuminated area. As a result, partial light emitted forward of the two ends of the LED light apparatuses is out of the illuminated area. Therefore, it is not benefit to take advantage of the emitted light. Moreover, the partial light will form spot in outside of the illuminated area which result in a poor light effects.

Therefore, it is necessary to provide the spread light lens and the LED strip light having the same to settle out the above art problem.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 is an isometric view of an LED strip light according to an embodiment.

FIG. 2 is an isometric exploded view of the LED strip light of FIG. 1.

FIG. 3 is an isometric view of a spread light lens of the LED strip light of FIG. 1.

FIG. 4 is an isometric view of the spread light lens of FIG. 3.

FIG. 5 is a light path view of the LED strip light of FIG. 1.

### DETAILED DESCRIPTION

The present application is illustrated by way of example and not by way of limitation in the figures of the accompanying drawings. It should be noted that references to “an” or “one” embodiment in this application are not necessarily to the same embodiment, and such references mean at least one.

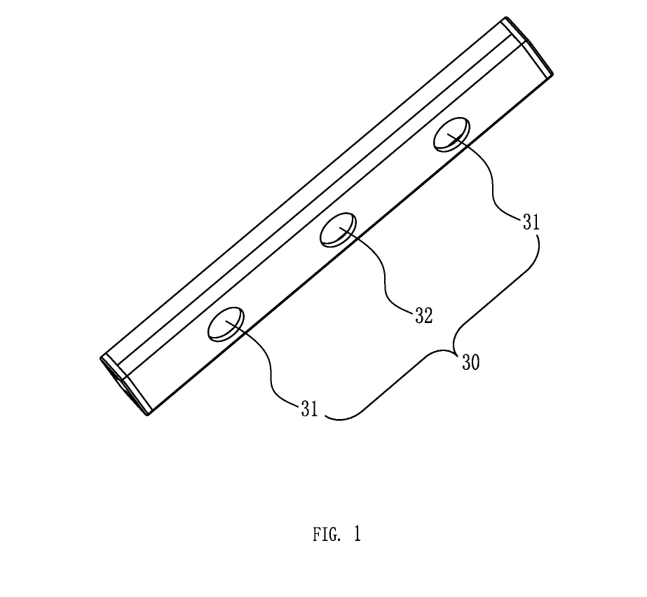

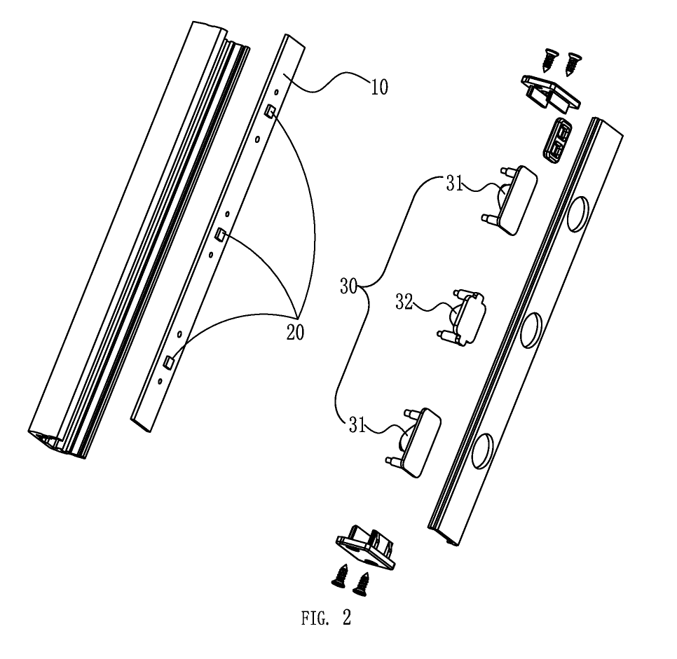

Referring to FIG. 1 and FIG. 2, an LED strip light 100 according to an embodiment is shown. The LED strip light 100 includes a printed circuit board 10, a plurality of LED chips 20 arranged on the printed circuit board 10 along length direction thereof, and a lens group 30 arranged on the printed circuit board 10 along light direction of the LED chips 20. It may be understood that the LED strip light 100 further includes a strip frame for housing the printed circuit board 10, a plurality of hole disposed on the strip frame for containing the lens group 30, end covers, wires, LED drivers, and so on. These function modules are well known for ordinary person skilled in the art, and not necessary to described in detail.

The printed circuit board 10 is configured to mount the LED chips 20 and supply power thereto. In the present embodiment, the printed circuit board 10 has a strip structure so as to mount the LED chips 20 along length direction thereof and form a strip luminous spot. About parameter and specification of the printed circuit board 10, it is not emphasis in the present embodiment and no need to describe in detail. Need to explain that two ends and middle part of the printed circuit board 10 are arranged along length direction thereof.

The LED chip 20 is a semiconductor light source and transforms power into light. The LED chip 20 presents many advantages over traditional light sources including lower energy consumption, longer lifetime, improved physical robustness, smaller size, and faster switching. In the present embodiment, there is a plurality of LED chips 20 arranged on the printed circuit board 10, and light direction of the LED chips 20 is parallel to an above optical axis 21 of a spread light lens 31. The LED chips 20 have same number with the lens of the lens group 30, that is to say, each of the LED chips 20 matches up one lens. Each of the LED chips 20 includes an LED optical axis 201.

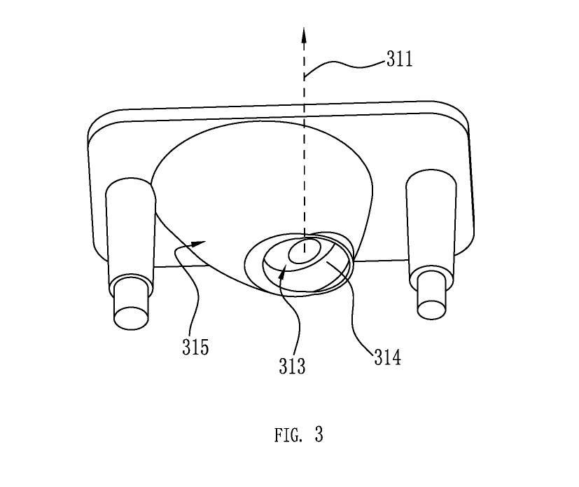

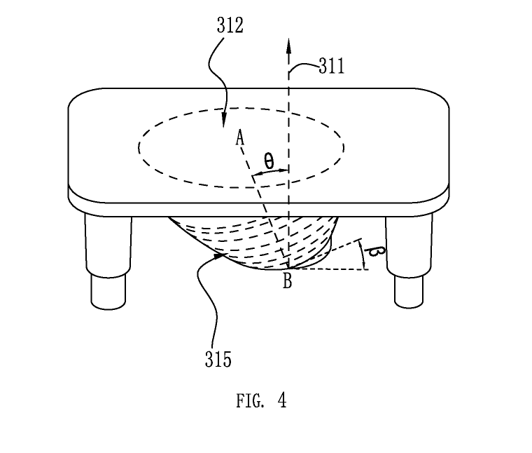

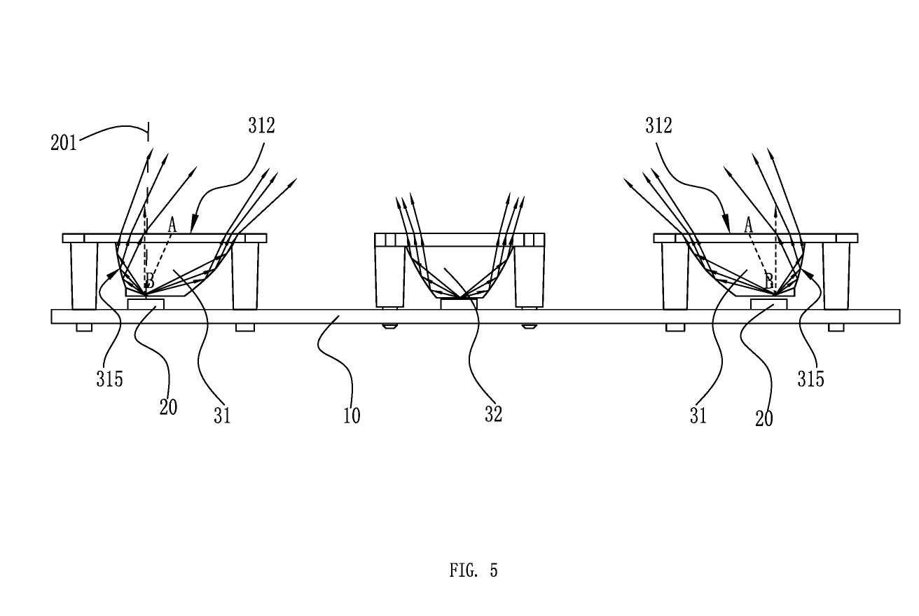

Referring to FIG. 3 and FIG. 4 together, the lens group 30 includes at least two spread light lens 31. Each of the two spread light lens 31 includes an optical axis 311, a light emitting surface 312 been perpendicular to the optical axis 311, and a light incidence surface 313 arranged at interval with the light emitting surface 312. A central point of the light incidence surface 313 is on the optical axis 311. A central point of the light emitting surface 312 is deviated from the optical axis 311. In the present embodiment, A stands for the central point of the light emitting surface 312 and B stands for the central point off the light incidence surface 313, and AB stands for the ligature between the central point of the light emitting surface 312 and the central point of the light incidence surface 313. A ligature AB between the central point A of the light incidence surface 313 and the central point B of the light emitting surface 312 is perpendicular to the light incidence surface 313 As shown in FIG. 4, θ stands for an angle between the ligature AB and the optical axis 311 and β stands for an angle between the light emitting surface 312 and the light incidence surface 313 in the present embodiment. Since the optical axis 311 is perpendicular to the light emitting surface 312, and the ligature AB is perpendicular to the light incidence surface 311, the angle θ between the ligature AB and the optical axis 311 is equal to an angle β between the light emitting surface 312 and the light incidence surface 313 so as to deflect the light emitted from the light emitting surface 312. The spread light lens 31 is made of transparent or semi-transparent material, such as glass, plastic, and so on. In the present embodiment, the spread light lens 31 is made of plastic. In order to easy to assembly, the spread light lens 31 includes at least a support for mounting it onto the printed circuit board 10. The support includes two legs and two extending body extending from the light emitting surface 312. The two legs are inserted into the printed circuit board 10 for assembling the spread light lens 31 and are disposed onto the two extending body respectively. The optical axis 311 is a universal feature for all of lens and used to dispose the light source, namely the LED chip 20. Moreover, the optical axis 311 is a guide for optic design. The optical axis 311 is overlapped with the LED optical axis 201. Referring to FIG. 5, the light emitting surface 312 of the spread light lens 31 of the LED strip light 100 is parallel to the printed circuit board 10. The ligature AB tilts to a central region of the printed circuit board 10 so as to deflect the light emitted from the light emitting surface 312 towards the middle part of the printed circuit board 10. As a result, the luminance of the two ends of the LED strip lights 100 is reduced.

The light emitting surface 312 may be a round plane and an elliptical plane in order that the light emitted from the LED strip light 100 along the length direction thereof is symmetric. In the present embodiment, the light emitting surface 312 is the elliptical plane and a major axis of the elliptical plane is arranged along the length direction of the printed circuit board 10 in order to deflect the emitted light towards the middle part of the printed circuit board 10.

The light incidence surface 313 may be a spherical surface having collecting light function for improving utilization of the emitted light.

The spread light lens 31 further includes a light source recess 314. The light source recess 314 is a hollow cylinder which has a central axis and is configured for containing the LED chip 20. The light source recess 314 is integrated into the spread light lens 31 and has a free end which is parallel to the light emitting surface 10 so as to improve the fit standard between the spread light lens 31 and the printed circuit board 10.

The spread light lens 31 further includes a critical reflection surface 315. The critical reflection surface 315 is arranged between the light incidence surface 313 and the light emitting surface 312. The critical reflection surface 315 is configured to receive the light emitted from the side wall of the light source recess 315 and reflecting the light into the light emitting surface 312 according to the law of total reflection.

The at least two spread light lens 31 is mounted on the two ends of the printed circuit board 10 respectively. It may be understood that the lens group 30 may includes two, three, or more the spread light lens 31. According to different light requirement, the number of the spread light lens 31 on one end of the printed circuit board 10 may be same or not same with that on another end thereof. In the present embodiment, the two ends of the printed circuit board 10 is respectively disposed one spread light lens 31 as a example as shown in FIG. 5.

The lens group 30 further includes a plano-convex lens 32 which is arranged between the at least two spread light lens 31. The plano-convex lens 32 has a uniform illumination and is disposed at same interval with the two spread light lens 31. That is to say that each of the lens of the lens group 30 is mounted on the printed circuit board 10 at regular interval so as to improve the uniform illumination.

As described above, the spread light lens 31 is arranged on end of the LED strip lights 100 and the ligature AB between the central point of the light emitting surface and the central point of the light incidence surface been perpendicular to the light incidence surface. In a result, the emitted light of the LED chips 20 is deflected towards the middle part of the printed circuit board so as to reduce the illumination on the two ends of the LED strip lights 100. Therefore, the LED strip lights 100 having the spread light lens 31 can avoid from forming bad lighting region which has dramatic light and shade contrast. Furthermore, the LED strip lights 100 are contributed to improve luminous efficacy of light source.

While the disclosure has been described by way of example and in terms of exemplary embodiment, it is to be understood that the disclosure is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A spread light lens, comprising:
an optical axis;
a light emitting surface been perpendicular to the optical axis, a central point of the light emitting surface been deviated from the optical axis; and
a light incidence surface arranged at interval with the light emitting surface, a central point of the light incidence surface being on the optical axis, a ligature between the central point of the light emitting surface and the central point of the light incidence surface being perpendicular to the light incidence surface and an angle between the ligature and the optical axis being equal to an angle between the light emitting surface and the light incidence surface so as to deflect the light emitted from the light emitting surface.

2. The spread light lens as claimed in claim 1, wherein the light emitting surface is a round plane.

3. The spread light lens as claimed in claim 1, wherein the light emitting surface is an elliptical plane.

4. The spread light lens as claimed in claim 1, wherein the light incidence surface is a spherical surface having collecting light function.

5. The spread light lens as claimed in claim 1, wherein the spread light lens further comprises a light source recess, the light source recess is a hollow cylinder which has a central axis, the central axis is overlapped with the optical axis.

6. The spread light lens as claimed in claim 1, wherein the light source recess has a free end which is parallel to the light emitting surface.

7. The spread light lens as claimed in claim 1, wherein the spread light lens further comprises a critical reflection surface disposed between the light emitting surface and the light incidence surface, the critical reflection surface is configured to reflect the light emitted forward of the light incidence onto the light emitting surface.

8. An LED strip light, comprising:
a printed circuit board;
a plurality of LED chip arranged on the printed circuit board along length direction thereof; and
a lens group arranged on the printed circuit board along the lighting direction of the LED chip, the lens group comprising at least two spread light lenses, the spread light lenses comprising an optical axis, a light emitting surface being perpendicular to the optical axis, a central point of the light emitting surface being deviated from the optical axis, and a light incidence surface arranged at interval with the light emitting surface, a central point of the light incidence surface being on the optical axis, a ligature between the central point of the light emitting surface and the central point of the light incidence surface being perpendicular to the light incidence surface and an angle between the ligature and the optical axis being equal to an angle between the light emitting surface and the light incidence surface so as to deflect the light emitted from the light emitting surface.

9. The LED strip light as claimed in claim 8, wherein each of the LED chips comprises an LED optical axis, the LED optical axis is overlapped with the optical axis.

10. The LED strip light as claimed in claim 8, wherein the at least two spread light lenses are disposed on two ends of the printed circuit board respectively along the length direction thereof.

11. The LED strip light as claimed in claim 8, wherein the light emitting surface of the spread light lenses is parallel to the printed circuit board.

12. The LED strip light as claimed in claim 8, wherein the ligature between the central point of the light emitting surface and the central point of the light incidence surface tilts to a central region of the printed circuit board so as to deflect the light emitted from the light emitting surface towards the middle part of the printed circuit board.

13. The LED strip light as claimed in claim 8, wherein the light emitting surface is an elliptical plane, and a major axis of the elliptical plane is arranged along the length direction of the printed circuit board.

14. The LED strip light as claimed in claim 8, wherein the lens group further comprises a plano-convex lens which is arranged between the two spread light lenses.
